(19) United States
(12) Patent Application Publication
(10) Pub. No.: US 2016/0042301 A1
(43) Pub. Date: Feb. 11, 2016

(54) SUPPORT OF MULTIPLE PASSENGER COUNTS IN A SINGLE TRAVEL SEARCH QUERY

(71) Applicant: Google Inc., Mountain View, CA (US)

(72) Inventors: Denis Chebikin, Bedford, MA (US); Todd A. Williamson, Brookline, MA (US)

(21) Appl. No.: 14/455,690

(22) Filed: Aug. 8, 2014

(51) Int. Cl. G06Q 10/02

(52) U.S. Cl. CPC G06Q 10/02

(57) ABSTRACT

Computer-implemented methods, software, and systems compute flight prices for several passenger counts simultaneously in one travel search query. One computer-implemented method includes receiving a travel search query, retrieving data from a data store applicable to the received travel search query, generating a plurality of itineraries from the retrieved data, generating one or more availability lines associated with each itinerary of the plurality of itineraries, each availability line indicating a number of seats available for travel for each of a plurality of booking codes for one or more flights associated with each availability line and a booking code condition, constructing a plurality of generated fares from the generated itineraries, the generated availability lines, and fare data, constructing generated fare combinations using the generated fares, generating possible pricing solutions from the constructed generated fare combinations, and storing the generated possible pricing solutions into a pricing graph.

### BACKGROUND

In a travel planning system (TPS), a maximum number of passengers for which a certain flight price is valid is governed primarily by the number of seats an airline makes available at that price. For example, if the cheapest fare for a flight has two seats available, then searching for the same flight with three passengers would yield a different (more expensive) fare. Travel planning users typically generate a travel search query for each particular number of passengers. However, executing multiple travel search queries is, among other things, computationally expensive and time consuming.

### SUMMARY

The present disclosure relates to computer-implemented methods, software, and systems for computing flight prices for several passenger counts simultaneously in one travel search query. A travel search query is received and data is retrieved from a data store applicable to the received travel search query. A plurality of itineraries are generated from the retrieved data and one or more availability lines associated with each itinerary of the plurality of itineraries are generated; each availability line indicating a number of seats available for travel for each of a plurality of booking codes for one or more flights associated with each availability line and a booking code condition. A plurality of generated fares is constructed from the generated itineraries, the generated availability lines, and fare data. Generated fare combinations are constructed using the generated fares and possible pricing solutions are generated from the constructed generated fare combinations. The generated possible pricing solutions are stored into a pricing graph.

The present disclosure relates to computer-implemented methods, software, and systems for computing flight prices for several passenger counts simultaneously in one travel search query. One computer-implemented method includes receiving, by a computer, a travel search query, retrieving, by a computer, data from a data store applicable to the received travel search query, generating, by a computer, a plurality of itineraries from the retrieved data, generating, by a computer, one or more availability lines associated with each itinerary of the plurality of itineraries, each availability line indicating a number of seats available for travel for each of a plurality of booking codes for one or more flights associated with each availability line and a booking code condition, constructing, by a computer, a plurality of generated fares (GFs) from the generated itineraries, the generated availability lines, and fare data, constructing, by a computer, generated fare combinations using the generated fares, generating, by a computer, possible pricing solutions from the constructed generated fare combinations, and storing, by a computer, the generated possible pricing solutions into a pricing graph.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

In a first aspect, combinable with the general implementation, wherein the retrieved data also includes one or more of air-carrier data, flight data, and fare data.

In a second aspect, combinable with the general implementation, wherein each itinerary of the plurality of itineraries comprises an availability line including air-carrier information, a flight identifier, a booking code, a number of seats available for the booking code, and particular restrictions unique to that availability line.

A third aspect, combinable with any of the previous aspects, comprising computing, by operation of a computer, a maximum passenger count for which a particular generated fare could be available in the context of some flight and availability line combination.

A fourth aspect, combinable with any of the previous aspects, wherein a generated fare contains information about the circumstances under which a particular fare is used.

A fifth aspect, combinable with any of the previous aspects, comprising efficiently representing the constructed generated fare combinations.

A sixth aspect, combinable with any of the previous aspects, comprising enumerating pricing solutions from the pricing graph.

A seventh aspect, combinable with any of the previous aspects, comprising selecting a group of fares that meet a plurality of diversity conditions.

An eighth aspect, combinable with any of the previous aspects, wherein the diversity conditions are used to fulfill a diversity strategy for a specified number of passengers.

A ninth aspect, combinable with any of the previous aspects, comprising scanning the pricing graph and disabling all generated fares that are valid for less than a specified number of passengers, K.

A tenth aspect, combinable with any of the previous aspects, comprising, for each diversity condition, determining whether all pricing solutions valid for K−1 passengers are valid for K passengers.

An eleventh aspect, combinable with any of the previous aspects, comprising enumerating valid pricing solutions using a remainder of the pricing graph for one or more unsatisfied diversity conditions.

The subject matter described in this specification can be implemented in particular implementations so as to realize one or more of the following advantages. First, a described solution takes advantage of existing travel planning algorithms by inserting objects (e.g., generated fares (GFs)) that encode maximum availability information into data structures used by existing travel search queries (e.g., pricing graphs). Simplicity of implementation is maintained by not changing a number of passengers in a particular travel search query and by not running multiple travel search queries. Second, from a single travel search query, multiple passenger-count fares can generated at a lesser computational cost than the computational cost of running a separate query for each passenger count. For example, a TPS could allow a user to change a number of passengers while viewing travel search query results, as the answers to the original travel search query would contain all the necessary information to refresh the results without running an additional travel search query. Third, if a TPS uses answer caching for instantaneous presentation of search results, then it is possible to fill a cache with results for passenger counts between 1 and N at a performance cost that is very small compared to an N-fold increase in computation that would result from using a separate query for each passenger count. Also, this invention could be valuable for some online travel agencies offering travel search, as it would allow displaying search results for different passenger counts without reissuing the search query. The feature will make it possible for users to search for 1 passenger first, and then refine their search to specify the true number of passengers and get nearly instantaneous results. Other advantages will be apparent to those skilled in the art.

The details of one or more implementations of the subject matter of this disclosure are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example travel planning system (TPS) for computing flight prices for several passenger counts simultaneously in one travel search query according to an implementation.

FIG. 2 is a flow chart illustrating a method for computing flight prices for several passenger counts simultaneously in one travel search query according to an implementation.

FIG. 3 is a flow chart illustrating a method for enumerating/diversifying pricing solutions according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein. For example, although the following description is focused on flight queries, the described subject matter can also be applied to other forms of travel planning such as that involving automobiles, trains, watercraft, attractions, and/or lodging.

The following subject matter generally describes computer-implemented methods, computer-program products, and systems for computing flight prices for several passenger counts simultaneously in one travel search query. In particular, a method permitting flight prices to be computed by a travel planning system (TPS) for several passenger counts simultaneously in a single travel search query is described, where each answer returned as part of a response to the travel search query represents a per-passenger flight price for the given flight valid for a certain range of passenger counts. For example, if the travel planning system returns an answer with a price of $500 and a passenger count range of 2-5, it would mean that a party of 2, 3, 4, or 5 passengers travelling together on an identified flight or itinerary would pay $500 per person. Note that a particular itinerary can include, in some instances, multiple flights.

The maximum number of passengers for which a certain flight price is valid is governed primarily by seat availability. For example, if the cheapest fare for a flight has 2 seats available, then searching for the same flight with 3 passengers would yield a different (more expensive) fare. The described method would also produce from a single travel search query both the cheapest price available for 1 or 2 passengers (matching the available seats available for the cheapest fare), as well as a more expensive price available for 3 passengers if booked at the same time. The supplied data is produced at a lesser computational cost than the computational cost of running a separate query for each passenger count.

In some implementations, the TPS can proactively fill a cache of flight search results using answers valid for different passenger counts. A user can then select a number of passengers up front as part of an initial travel search query and the results for the selected passenger count can be immediately retrieved from the cache, if available.

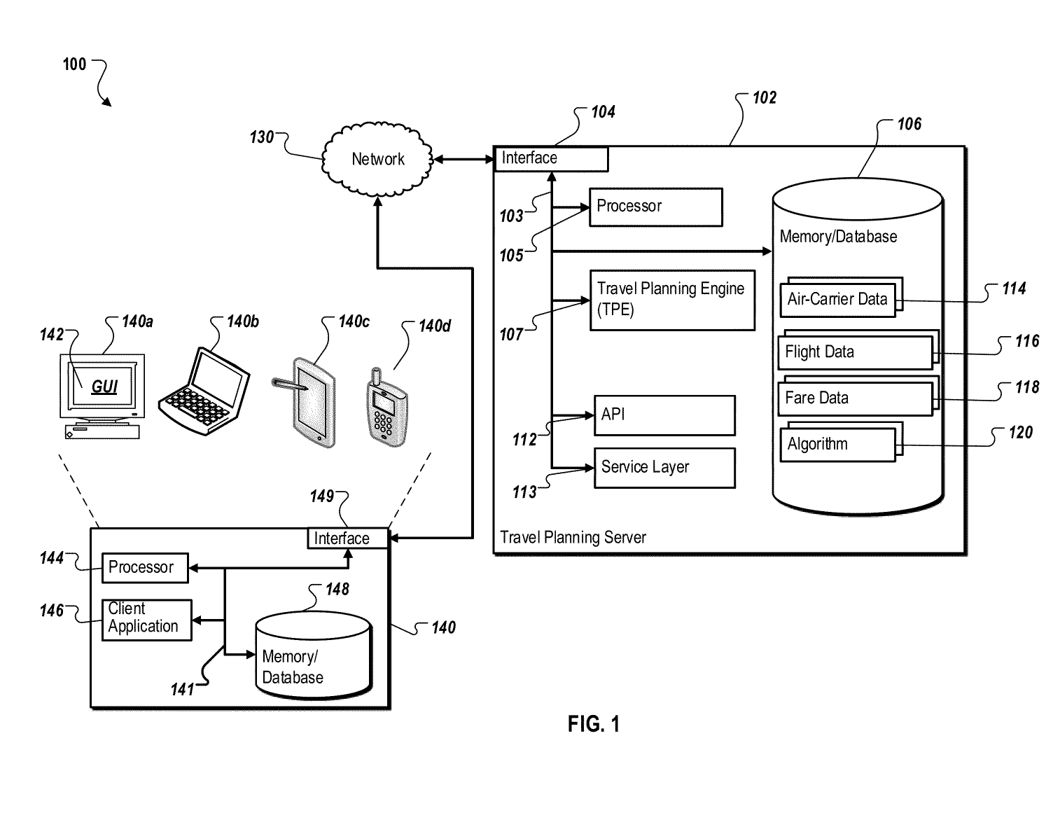

FIG. 1 is a block diagram illustrating an example travel planning system (TPS) 100 for computing flight prices for several passenger counts simultaneously in one travel search query. The illustrated TPS 100 includes, or is communicably coupled with, a travel planning server 102 and a client 140 communicating across a network 130. While FIG. 1 depicts a client-server environment, FIG. 1 could also represent a portion of a cloud-computing environment.

At a high level, the travel planning server 102 is an electronic computing device operable to receive, transmit, process, store, or manage data and information associated with the TPS 100. In some implementations, a travel-planning server 102 user, for example using a client 140, is provided with an efficient and user-friendly presentation of data provided by or communicated within the example TPS 100 (e.g., through a graphical user interface (GUI)).

In general, the travel planning server 102 provides functionality appropriate to a server, including database functionality and receiving/serving content and/or functionality from/to a client permitting, for example, computation of flight prices for several passenger counts simultaneously in one travel search query, as described herein. The travel planning server 102 is also responsible for receiving application requests from a client 140 (as well as any other entity or system interacting with the travel planning server 102), for example to processes a travel search query responding to the received requests by processing said requests in an associated TPE 107, and sending the appropriate responses from the TPE 107 back to the requesting client 140 and/or other requesting system. The TPE 107 can also process and respond to local requests from a user accessing the associated travel planning server 102. Accordingly, in addition to requests from the client 140, requests associated with a particular TPE 107 may also be sent from internal users, external or third-party customers, other applications, and/or any other appropriate entities, individuals, systems, or computers.

In alternative implementations, the elements illustrated within the travel planning server 102 and/or the client 140 may be included in or associated with different and/or additional servers, clients, networks, or locations other than those illustrated in FIG. 1. For example, according to some implementations, the travel planning server 102 may also include or be communicably coupled with an e-mail server, a web server, a caching server, a streaming data server, a business intelligence (BI) server, and/or other server. Additionally, the functionality associated with the travel planning server 102 may be associated with any suitable system, including by adding additional instructions, programs, applications, or other software to existing systems. For example, the components illustrated within the travel planning server 102 may be included in multiple servers, cloud-based networks, or other locations accessible to the travel planning server 102 (e.g., either directly or through network 130).

In some implementations, the travel planning server 102 can store and execute various other applications (not illustrated), while in other implementations, the travel planning server 102 may be a dedicated server meant to store and execute a particular TPE 107 and related functionality. In some implementations, the travel planning server 102 can contain a web server or be communicably coupled with a web server, where the particular TPE 107 associated with that travel planning server 102 represents a web-based (or web-accessible) application accessed and/or executed on an associated client 140 to perform the programmed tasks or operations of the corresponding TPE 107. In some implementations, the TPE 107 can execute functionality associated with other local, remotely networked, and/or cloud-based applications (not illustrated). In still other implementations, the TPE 107 may be executed on a first system, while the TPE 107 manipulates and/or provides information for data located at a remote, second system.

Each of the components of the travel planning server 102 can communicate using a system bus 103. In some implementations, any and/or all the components of the travel planning server 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the TPS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the travel planning server 102 in the TPS 100, alternative implementations may illustrate the API 112 and/or the service layer 113 as stand-alone components in relation to other components of the TPS 100. Moreover, any or all parts of the API 112 and/or the service layer 113 may be implemented as child or sub-modules of another software module, enterprise application, or hardware module without departing from the scope of this disclosure. For example, the API 112 could be integrated into the database 106, the server application 107, and/or wholly or partially in other components of server 102 (whether or not illustrated).

The travel planning server 102 includes an interface 104. Although illustrated as a single interface 104 in FIG. 1, two or more interfaces 104 may be used according to particular needs, desires, or particular implementations of the TPS 100. The interface 104 is used by the travel planning server 102 for communicating with other systems in a distributed environment—including within the TPS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated TPS 100.

The travel planning server 102 includes a processor 105. Although illustrated as a single processor 105 in FIG. 1, two or more processors may be used according to particular needs, desires, or particular implementations of the TPS 100. Generally, the processor 105 executes instructions and manipulates data to perform the operations of the server 102. Specifically, the processor 105 executes the functionality required for computing flight prices for several passenger counts simultaneously in one travel search query.

Generally, the travel planning server 102 may be communicably coupled with a network 130 that facilitates communications between the components of the example TPS 100 (e.g., between the travel planning server 102 and the at least one client 140), as well as with any other local or remote computer, such as additional clients, servers, or other devices communicably coupled to network 130, including those not illustrated in FIG. 1. In the illustrated example travel planning system 100, the network 130 is depicted as a single network, but may be comprised of more than one network without departing from the scope of this disclosure, so long as at least a part of the network 130 may facilitate communications between senders and recipients. The network 130, however, is not a required component in some implementations of the present disclosure.

The travel planning server 102 also includes a memory 106 (e.g., a database) that holds data for the travel planning server 102. Although illustrated as a single memory 106 in FIG. 1, two or more memories may be used according to particular needs, desires, or particular implementations of the example TPS 100. While memory 106 is illustrated as an integral component of the travel planning server 102, in alternative implementations, memory 106 can be external to the travel planning server 102 and/or the example TPS 100. In some implementations, the memory 106 can be configured to store one or more instances of air-carrier data 114, flight data 116 (including fare rules and the application of fares), fare data 118 , and/or an algorithm 120.

In some implementations, air-carrier data 114 represents an air carrier name, address, identification number, abbreviation, countries of service, airport hub, or any other suitable data with respect to an air carrier. For example, a particular air carrier may have data stored in the at least one air-carrier data 114 instance as the name “Airborne Airlines”, address “1234 Airport Row, Flight City, MA 75001”, identification number “3170”, abbreviation “AA”, countries of service “US and UK”, and airport hub “BOS.” Other representations and types of air-carrier data may be used and/or stored without departing from the scope of the disclosure.

Flight data 116 instance may store information about one or more flights. For example, data for a flight may be represented as “AA flight 101 BOS-LHR.” In this example, a flight 101 on carrier AA from Boston, Mass. USA (BOS) to London Heathrow Airport, UK (LHR) The example flight data 118 illustrated in this disclosure is to be considered representative only, and one of ordinary skill will appreciate that in other implementations, the flight data 116 may be represented in numerous other ways without departing from the scope of the disclosure.

The fare data 118 represents price data and/or conditions (e.g., rules) used to determine a fare associated with one or more flights segments. In some implementations, fare data 118 may also include, for example, air carriers, origin/destination endpoints, conditions for application of the fare, or other suitable data associated with the fare. The example fare data 118 illustrated in this disclosure is to be considered representative only, and one of ordinary skill will appreciate that in other implementations, the fare data may be represented in numerous other ways without departing from the scope of the disclosure.

Algorithm 120 may represent an engine (e.g., an algorithmic software engine) including one or more conditions, parameters, variables, instructions, constraints, references, and any other appropriate information for processing a received travel search query and/or computing flight prices for several passenger counts simultaneously in one travel search query. For example, the travel planning engine 107 (or other element of the TPS 100) can use algorithm 120 to perform aspects of its functionality.

A travel planning engine (TPE) 107 is illustrated within the travel planning server 102. Although illustrated as a single TPE 107, two or more TPEs 107 may be used with the travel planning server 102 according to particular needs, desires, or particular implementations of the specific environment. The TPE 107 can be any application, program, module, process, or other software that may provide methods for computing flight prices for several passenger counts simultaneously in one travel search query. In some implementations, the TPE 107 can access, process, and/or modify air-carrier data 114, flight data 116, fare data 118, and/or other data. In some implementations, a particular TPE 107 can operate in response to and in connection with at least one request received from a client 140. Additionally, a particular TPE 107 may operate in response to and in connection with at least one request received from other TPEs 107, including TPEs 107 associated with other travel planning servers 102. In some implementations, each TPE 107 can represent a web-based application accessed and executed by one or more remote clients 140 across the network 130 (e.g., through the Internet, or using at least one cloud-based service associated with the TPE 107). For example, part of a particular TPE 107 may be a web-based service associated with a TPE 107 that is remotely called, while another part of the particular TPE 107 may be an interface object or agent bundled for processing at a remote client 140. Moreover, any or all of a particular TPE 107 may be a child or sub-module of another software module or enterprise application (not illustrated). Still further, parts of the particular TPE 107 may be executed or accessed by a user working directly at the travel planning server 102, as well as remotely at a corresponding client 140. In some implementations, the air-carrier data 114, flight data 116, fare data 118, algorithm 120, and/or other data can be defined with and/or stored within the TPE 107 as opposed to memory/database 106.

The client 140 may be any computing device operable to connect to and/or communicate with at least the travel planning server 102 using the network 130. In general, the client 140 comprises an electronic computing device operable to receive, transmit, process, and store any appropriate data associated with the TPS 100, for example, the TPE 107. More particularly, among other things, the client 140 can collect and transmit/upload content to the server 102 for integration/processing into/by the TPE 107. The client typically includes a processor 144, a client application 146, a memory/database 148, and/or an interface 149 interfacing over a system bus 141.

The client application 146 is any type of application that allows the client 140 to navigate to/from, request, view, create, edit, delete, administer, and/or manipulate content associated with the travel planning server 102 and/or the client 140. For example, the client application 146 can present GUI displays and associated data to a user that are generated/transmitted by the travel planning server 102 (e.g., the TPE 107 and/or memory/database 106) to permit a user to compute flight prices for several passenger counts simultaneously in one travel search query, accept user input, and transmit the user input to the travel planning server 102 for dissemination to the appropriate components of travel planning server 102, in particular the TPE 107 and/or the memory/database 106. In some implementations, the client application 146 can use parameters, metadata, and other information received at launch to access a particular set of data from the travel planning server 102 and/or other components of the TPS 100. Once a particular client application 146 is launched, a user may interactively process a task, event, or other information associated with the travel planning server 102 and/or other components of the TPS 100. For example, the client application 146 can generate and transmit a particular database request/query to the travel planning server 102.

In some implementations, the client application 146 can also be used perform administrative functions related to the TPE 107, memory/database 106, and/or the travel planning server 102 in general. For example, the TPE 107 can generate and/or transmit administrative pages to the client application 146 based on a particular user login, request, etc. to allow updating of algorithms 120, POS data 122, booking partner specifications 124, and/or other data on the travel planning server 102.

Further, although illustrated as a single client application 146, the client application 146 may be implemented as multiple client applications in the client 140. For example, there may be a native client application and a web-based (e.g., HTML) client application depending upon the particular needs of the client 140 and/or the TPS 100.

The interface 149 is used by the client 140 for communicating with other computing systems in a distributed computing system environment, including within the TPS 100, using network 130. For example, the client 140 uses the interface to communicate with a travel planning server 102 as well as other systems (not illustrated) that can be communicably coupled to the network 130. The interface 149 may be consistent with the above-described interface 104 of the travel planning server 102. The processor 144 may be consistent with the above-described processor 105 of the travel planning server 102. Specifically, the processor 144 executes instructions and manipulates data to perform the operations of the client 140, including the functionality required to send requests to the travel planning server 102 and to receive and process responses from the travel planning server 102.

The memory/database 148 typically stores objects and/or data associated with the purposes of the client 140 but may also be consistent with the above-described database 106 and/or memory/database 106 of the travel planning server 102 or other memories within the TPS 100 and be used to store data similar to that stored in the other memories of the TPS 100 for purposes such as backup, caching, and the like. Although illustrated as a combined memory/database, in some implementations, the memory and database can be separated.

Further, the illustrated client 140 includes a GUI 142 that interfaces with at least a portion of the TPS 100 for any suitable purpose. For example, the GUI 142 (illustrated as associated with client 140a) may be used to view data associated with the client 140, the travel planning server 102, or any other component of the TPS 100. In particular, in some implementations, the client application 146 may render GUI interfaces received from the TPE 107 and/or data retrieved from any element of the TPS 100.

There may be any number of clients 140 associated with, or external to, the TPS 100. For example, while the illustrated TPS 100 includes one client 140 communicably coupled to the travel planning server 102 using network 130, alternative implementations of the TPS 100 may include any number of clients 140 suitable to the purposes of the TPS 100. Additionally, there may also be one or more additional clients 140 external to the illustrated portion of the TPS 100 that are capable of interacting with the TPS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140d) is intended to encompass any computing device such as a desktop computer/server, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142 (illustrated by way of example only with respect to the client 140a).

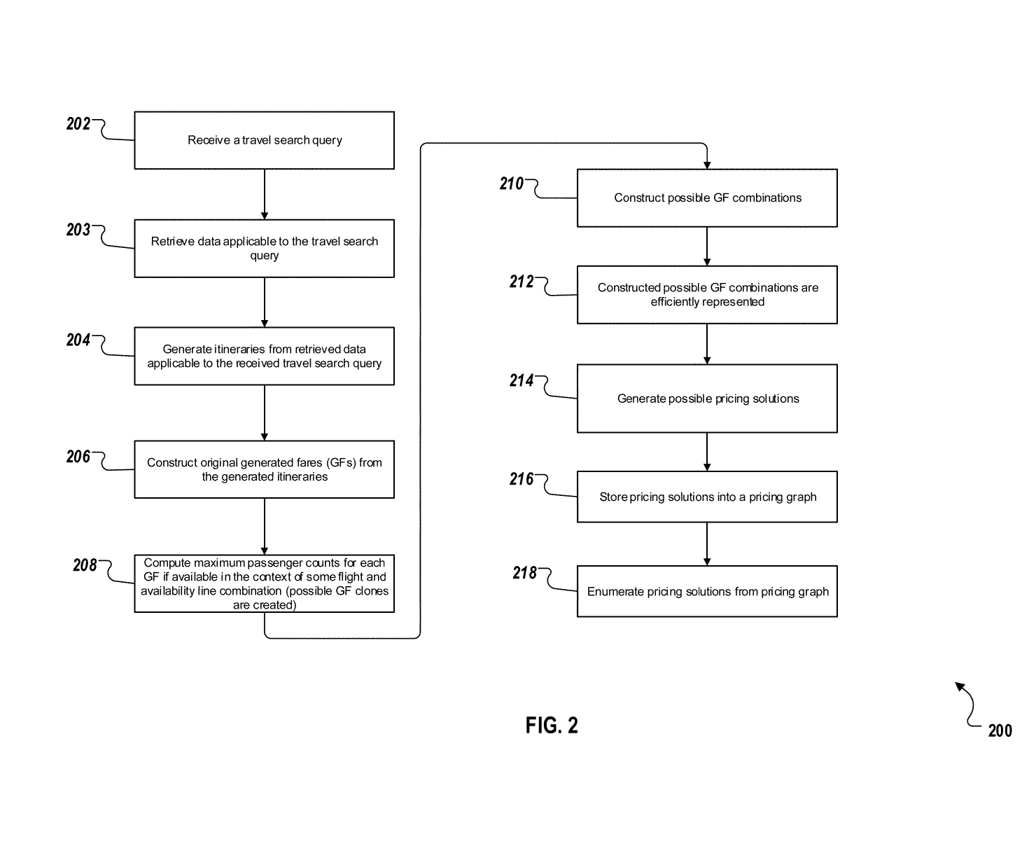

FIG. 2 is a flow chart illustrating a method 200 for computing flight prices for several passenger counts simultaneously in one travel search query according to an implementation. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate. Example data referred to in the description of method 200 is for representative purposes only and is not meant to limit the disclosure in any way.

The following description of method 200 assumes the most common case when a travel party consists of several adult passengers (i.e., no older children, children, or infants). It also relies on the following two assumptions:
1) Companion fares—fares that offer a cheaper price if the passenger is accompanied by another passenger paying “full” price—are not available to “generic” adult passengers; and
2) For every flight segment, all passengers on the ticket must be booked in the same booking code on that segment.
   In typical industry implementations, the second assumption holds true for almost all consumer websites. Also, typical industry messaging standards for passenger name records only allow a single booking code per segment across all passengers booked together. A safe assumption is that all passengers on the ticket will use the same set of fares. Therefore, the only reason a per-person price would vary with the number of passengers is seat availability.

The method 200 incorporates a new feature into travel search queries—a special mode for 1-passenger queries. In this mode, most stages of flight and fare processing are performed normally (as fares valid for 1 passenger will include all fares valid for multiple passengers, per the above assumptions). The TPS will build flight combinations that satisfy a user travel search query and retrieve fares that could be used to pay for those flights. It will apply fare rules and construct objects representing pricing units. Note that a “pricing unit” is an airline industry term for a group of fares that (usually) can be sold together as a single ticket but that may not necessarily be available for sale individually (for example, a so-called “half-roundtrip” fare cannot be sold on its own but must be paired with at least one other fare in a pricing unit). The following example will be used to illustrate subsequent processing of a travel search query in “multiple passenger counts” mode. It is at this stage that special processing of varying passenger counts will start.

At 202, a travel search query is received. From 202, method 200 proceeds to 203.

At 203, data applicable to the received travel search query is retrieved. For example, the received travel search query might request a flight from Boston (BOS) to San Antonio (SAT) within a range of specified times. The query is processed and data applicable to the travel search query is retrieved from air-carrier data, flight data, fare data, fare rules, and/or other data. From 203, method 200 proceeds to 204.

At 204, itineraries are generated from the retrieved data. For example, suppose the processing of the received travel search query involves considering the following two determined flight combinations:
Itinerary #1: BOS AA101 DFW AA201 SAT
Itinerary #2: BOS AA102 DFW AA202 SAT.
   For example, itinerary #1 reads “Boston to Dallas/Fort Worth International Airport on carrier AA, flight 101 and from Dallas/Fort Worth International Airport to San Antonio on carrier AA, flight 201. In turn, itinerary #2 reads “Boston to Dallas/Fort Worth International Airport on carrier AA, flight 102 and from Dallas/Fort Worth International Airport to San Antonio on carrier AA, flight 202.

Again, suppose that the following response regarding the above itineraries has been received from the TPS, a flight availability server, and/or other server:
Itinerary #1 (BOS AA101 DFW AA201 SAT):

Availability line #1: AA101 K3 L3 Y5 AA201 K1 L3 Y5 same BC

Availability line #2: AA101 K1 L3 Y5 AA201 K3 L3 Y5 different BC.
Itinerary #2 (BOS AA102 DFW AA202 SAT):

Availability line #3: AA102 K4 L5 Y5 AA202 K3 L3 Y5.

An “availability line” is an answer returned by the TPS, a flight availability server, and/or other server in response to an availability query for a sequence of flights. Note that for the same sequence of flights, the availability server can return multiple availability lines, each of which can have particular conditions/restrictions unique to that availability line. For example, Availability line #1 and #2 above with respect to “same BC” and “different BC,” respectively (the “same BC” and “different BC” restrictions mean that the availability line is valid only if the same (resp., different) booking code is used on the both segments of the itinerary (i.e., BOS→DFW and DFW→SAT)). For Itinerary #1, Availability line #1, flight AA101, the notation “K3” means that there are 3 seats available in booking code K for the flight (likewise 3 seats are available for booking code L and 5 seats are available for booking code Y).

Suppose the fares covering these flights include:
AA BOSSAT fare K14BOW, $300 (K fare that covers travel between BOS and SAT)
AA BOSDFW fare K14DOW, $200 (K fare that covers travel between BOS and DFW)
AA DFWSAT fare K14SOW, $150 (K fare that covers travel between DFW and SAT)
AA BOSSAT fare L07BOW, $525 (L fare that covers travel between BOS and SAT)
AA BOSDFW fare L07DOW, $350 (L fare that covers travel between BOS and DFW)
AA DFWSAT fare L07SOW, $200 (L fare that covers travel between DFW and SAT)
AA BOSSAT fare Y03BOW, $800 (Y fare that covers travel between BOS and SAT)
AA BOSDFW fare Y03DOW, $600 (Y fare that covers travel between BOS and DFW)
AA DFWSAT fare Y03SOW, $300 (Y fare that covers travel between DFW and SAT).
   From 204, method 200 proceeds to 206.

At 206, original generated fares (GFs) are constructed from the generated itineraries. A “generated fare” is an internal data object/structure of any suitable type (e.g., an array, linked list, and/or other data object/structure) created by the TPS to represent a fare. Each GF contains information about the circumstances under which a particular fare is used, and sometimes multiple GFs are created for the same fare. For simplicity, this description assumes that in the example above only one GF has originally been produced for each fare, and that the first letter of the fare code (e.g., “K” in “K14BOW”) is the only valid booking code choice for that fare on any flight segment.

For example, a GF for 1 passenger for Itinerary #1 above would resemble:

GF #1: AA BOSSAT K14BOW—original GF.

From 206, method 200 proceeds to 208.

At 208, query processing will examine the GFs, and for each such GF, it will compute maximum passenger counts for which the GF could be available in the context of some flight and availability line combination. For example, for each of the possible maximum counts except the largest one, the TPS will create a “clone” of the original GF, marking that clone as valid for passenger counts up to the corresponding maximum count. The original GF will be associated with the maximum possible passenger count for which the GF can be available.

For example, using GF #1 described above and considering booking code K, the GF is available for just 1 passenger for Itinerary #1 as the corresponding booking code K has just 1 seat available on at least one of the segments, regardless of availability line #1 or #2). Note that for Itinerary #2, booking code K is available for up to 3 passengers as the second segment has a maximum of 3 seats with booking code K. Therefore, the possible maximum passenger counts for GF #1 are 1 and 3 (availability lines #1 and 2, respectively).

The “original” GF #1 will therefore have a maximum passenger count of 3 (from availability line #2—the highest maximum passenger count), and one “clone” GF will be constructed with a maximum passenger count of 1 (the lowest maximum passenger count), and will be otherwise identical to GF #1.

Similarly, zero or more “clones” will be made for other GFs. For example:
GF #1: AA BOSSAT K14BOW up to 3 passengers
GF #100*: AA BOSSAT K14BOW up to 1 passenger
GF #2: AA BOSDFW K14DOW up to 4 passengers
GF #101*: AA BOSDFW K14DOW up to 3 passengers
GF #102*: AA BOSDFW K14DOW up to 1 passenger
GF #3: AA DFWSAT K14SOW up to 3 passengers
GF #103*: AA DFWSAT K14SOW up to 1 passenger
GF #4: AA BOSSAT L07BOW up to 3 passengers
GF #5: AA BOSDFW L07DOW up to 5 passengers
GF #104*: AA BOSDFW L07DOW up to 3 passengers
GF #6: AA DFWSAT L07SOW up to 3 passengers
GF #7: AA BOSSAT Y03BOW up to 5 passengers
GF #8: AA BOSDFW Y03DOW up to 5 passengers
GF #9: AA DFWSAT Y03SOW up to 5 passengers.
Note that asterisks identify “clone” GFs in this example. Also note that no clones were made for booking code “Y” because in both itineraries and in all availability lines, passenger count is consistently 5. From 208, method 200 proceeds to 210.

At 210, the “clone” GFs are used in a TPS algorithm that puts together pricing unit structures (which encode combinations of GFs and flights they cover) into complete pricing solutions. More specifically, the clone GFs are used when considering all GF combinations for a given itinerary and a given division of the itinerary into flight sequences covered by individual fares (“faring atoms”) to generate possible GF combinations.

For example, consider Itinerary #1 and its division AA101+AA201 (meaning that flight AA101 is to be covered by one fare, and flight AA201 is to be covered by a different fare). Without the “multiple passenger counts” mode, the procedure would have come up with the following GF combinations for an airline trip between BOS and SAT:
GF #2 K+GF #3 K (can use availability line #1)
GF #2 K+GF #6 L (can use availability line #2)
GF #2 K+GF #9 Y (can use availability line #2)
GF #5 L+GF #3 K (can use availability line #2)
GF #5 L+GF #6 L (can use availability line #1)
GF #5 L+GF #9 Y (can use availability line #2)
GF #8 Y+GF #3 K (can use availability line #2)
GF #8 Y+GF #6 L (can use availability line #2)
GF #8 Y+GF #9 Y (can use availability line #1).
(Note that the letters K, L, Y denote the booking code corresponding to each GF).

All of the above combinations are valid if there is just 1 passenger. TPS would represent this set of combinations as a simple cross product:

(GF #2 GF #5 GF #8)×(GF #3 GF #6 GF #9).

With the “multiple passenger counts” feature, the algorithm examining the above GF combinations would take into account the number of seats available in the booking code corresponding to the GF covering each flight, and it would use either the original GF or one of its “clones” depending on the number of available seats. The result would also depend on the particular availability line in question. Therefore, for the example above, the modified combinations would resemble:
GF #101 K (3)+GF #103 K (1) (availability line #1)
GF #102 K (1)+GF #6 L (3) (availability line #2)
GF #102 K (1)+GF #9 Y (5) (availability line #2)
GF #104 L (3)30 GF #3 K (3) (availability line #2)
GF #104 L (3)+GF #6 L (3) (availability line #1)
GF #104 L (3)+GF #9 Y (5) (availability line #2)
GF #8 Y (5)+GF #3 K (3) (availability line #2)
GF #8 Y (5)+GF #6 L (3) (availability line #2)
GF #8 Y (5)+GF #9 Y (5) (availability line #1).
(Note that numbers in parentheses show the number of available seats in the relevant booking code). From 210, method 200 proceeds to 212.

At 212, in some implementations, the combinations are subjected to an algorithm which creates efficient representations (e.g., in computer memory, a database, etc.) of the combinations. Regardless of whether the combinations are efficiently represented, a Cartesian product of the combinations is generated. For example:
(GF #104 GF #8)×(GF #3 GF #6 GF #9)+(GF #100)×(GF #6 GF #9)+(GF #101)×(GF #103).
   From 212, method 200 proceeds to 214.

At 214, pricing solutions, each pricing solution contains one or more fares, are generated from the Cartesian product as the end product of the travel search query.

Generally, a pricing solution can be considered an itinerary and a set of fares covering the flights in the itinerary. For example, the following shows the 24 valid ways to price the two itineraries and the number of passengers for which each price is available:
Itinerary #1: AA101 AA201

S #1: K14BOW $300 up to 1 passenger availability line #1

S #2: K14DOW+K14SOW $350 up to 1 passenger availability line #1

S #3: K14DOW+L07SOW $400 up to 1 passenger availability line #2

S #4: K14DOW+Y03SOW $500 up to 1 passenger availability line #2

S #5: L07DOW+K14SOW $500 up to 3 passengers availability line #2

S #6: L07BOW $525 up to 3 passengers availability line #1

S #7: L07DOW+L07SOW $550 up to 3 passengers availability line #1

S #8: L07DOW+Y07SOW $650 up to 3 passengers availability line #2

S #9: Y03DOW+K14SOW $750 up to 3 passengers availability line #2

S #10: Y03DOW+L07SOW $800 up to 3 passengers availability line #2

S #11: Y03BOW $800 up to 5 passengers availability line #1

S #12: Y03DOW+Y03SOW $900 up to 5 passengers availability line #1.
Itinerary #2: AA102 AA202 (all use availability line #3)

S #13: K14BOW $300 up to 3 passengers

S #14: K14DOW+K14SOW $350 up to 3 passengers

S #15: K14DOW+L07SOW $400 up to 3 passengers

S #16: K14DOW+Y03SOW $500 up to 4 passengers

S #17: L07DOW+K14SOW $500 up to 3 passengers

S #18: L07BOW $525 up to 3 passengers

S #19: L07DOW+L07SOW $550 up to 3 passengers

S #20: L07DOW+Y07SOW $650 up to 5 passengers

S #21: Y03DOW+K14SOW $750 up to 3 passengers

S #22: Y03DOW+L07SOW $800 up to 3 passengers

S #23: Y03BOW $800 up to 5 passengers

S #24: Y03DOW+Y03SOW $900 up to 5 passengers.

From 214, method 200 proceeds to 216.

At 216, the generated pricing solutions are stored in a pricing graph. TPS will represent the example 24 possible pricing solutions in a compact structure called a pricing graph. Use of a pricing graph representation is disclosed in issued U.S. Pat. No. 6,275,808, titled “Pricing Graph Representation for Sets of Pricing Solutions for Travel Planning System,” the entire disclosure of which is hereby incorporated by reference, and U.S. Pat. No. 6,609,098, titled “Pricing Graph Representation for Sets of Pricing Solutions for Travel Planning System,” the entire disclosure of which is hereby incorporated by reference. In “multiple passenger counts” mode, both “original” and “clone” GFs will be put into the pricing graph to reflect the information about the maximum number of passengers for which the solutions are valid. For example, the combination of fares in solution S#5 would be represented in the pricing graph by GF #104 and GF #3. From 216, method 200 proceeds to 218.

At 218, the “best” pricing solutions are enumerated from the pricing graph. An enumeration and diversity algorithm is also used to ensure output of enough answers to fulfill a diversity strategy for each passenger count. A diversity strategy is a collection of conditions (or “bins”) defining a subset of possible trips satisfying the received travel search query, with a desired number of solutions for each condition. For example, one of the conditions in the diversity strategy may ask for 5 solutions where the outbound flight is on carrier AA and departs between 8 am and 12 pm. If a certain diversity condition asks for 5 solutions, then a normal TPS query without the “multiple passenger counts” mode will return 5 solutions satisfying the condition, each of which is valid (available) for 1 passenger (or fewer than 5 solutions if there are fewer than 5 possible trips satisfying the condition).

For the “multiple passenger counts” mode enhancement, the query will also return 5 solutions that are valid for 2 passengers, 5 solutions that are valid for 3 passengers, and so on. Of course, these sets of 5 solutions could overlap, so TPS will output each solution only once, tagging it with the range of passenger counts for which it is intended. For example, if out of the 5 solutions output for 1 passenger, 4 are available for 2 or more passengers and 1 is available for just 1 passenger, then the set of 5 solutions output for 2 passengers will include the first 4 solutions output for 1 passenger. The 5th solution output for 2 passengers could be the same trip as the 5th solution output for 1 passenger priced with a more expensive fare, or it could be a trip that was not returned for 1 passenger, if that trip has a better price than the increased price of the 5th solution output for 1 passenger.

If a diversity condition asks for 1 solution on carrier AA, then the cheapest pricing solution for each passenger count from the pricing solution list above will be output:
S #13: AA102 AA202 $300 intended for 1-3 passengers
S #16: AA102 AA202 $500 intended for 4 passengers
S #20: AA102 AA202 $650 intended for 5 passengers.

Note that the enumeration algorithm may prefer instead to output S #1 as the cheapest pricing solution for 1 passenger, in which case the output would be as follows:
S #1: AA101 AA201 $300 intended for 1 passenger
S #13: AA102 AA202 $300 intended for 2-3 passengers
S #16: AA102 AA202 $500 intended for 4 passengers
S #20: AA102 AA202 $650 intended for 5 passengers.

If a diversity condition asks for 2 pricing solutions on carrier AA, then the output would resemble:
S #1: AA101 AA201 $300 intended for 1 passenger
S #13: AA102 AA202 $300 intended for 1-3 passengers
S #5: AA101 AA201 $500 intended for 2-3 passengers
S #16: AA102 AA202 $500 intended for 4 passengers
S #20: AA102 AA202 $650 intended for 5 passengers
S #11: AA101 AA201 $800 intended for 4-5 passengers.
   This output includes 2 pricing solutions for each passenger count between 1 and 5. After 218, method 200 stops.

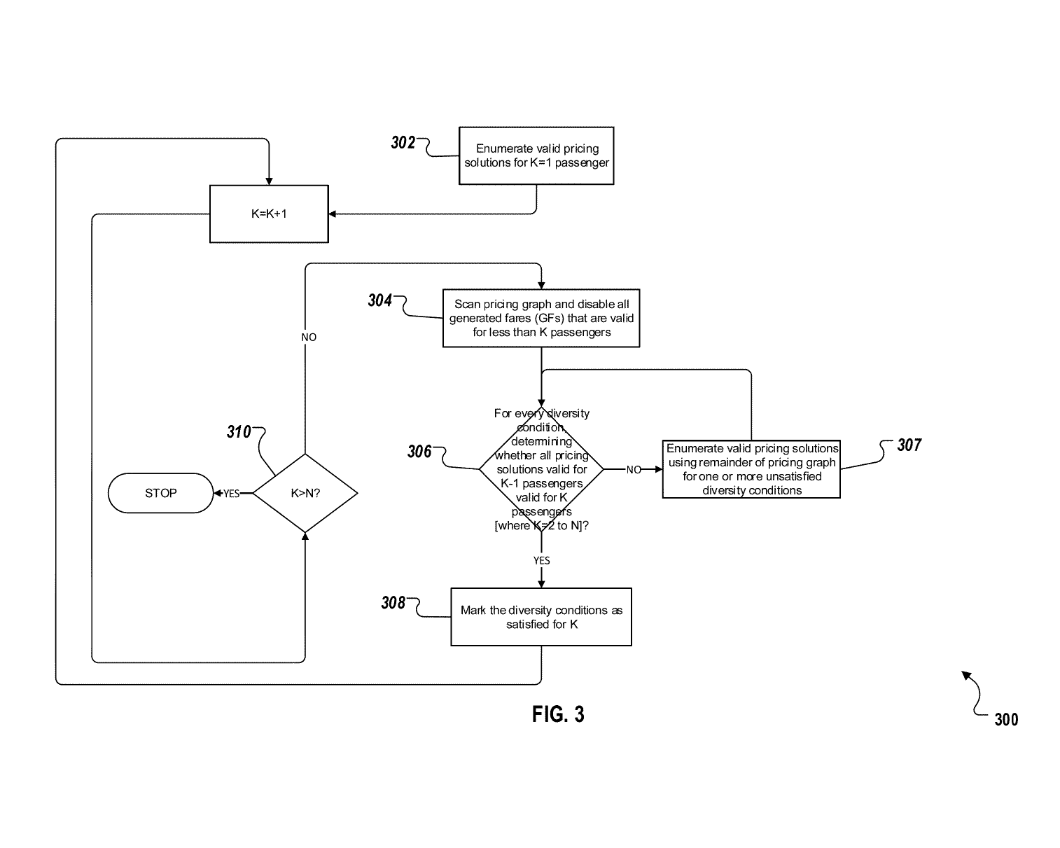

FIG. 3 is a flow chart illustrating a method 300 for enumerating/diversifying pricing solutions according to an implementation. For clarity of presentation, the description that follows generally describes method 300 in the context of FIGS. 1 and 2. However, it will be understood that method 300 may be performed, for example, by any other suitable system, environment, software, and hardware, or a combination of systems, environments, software, and hardware as appropriate. Example data referred to in the description of method 300 is for representative purposes only and is not meant to limit the disclosure in any way.

At 302, initial pricing solutions valid for K=1 passenger are enumerated to satisfy a diversity strategy specified in the query. From 302, method 300 proceeds to 304. Note: 304-308 are performed for each K passengers between 2 and N, where N is the maximum passenger count considered by the query. Referring to the examples provided above, the result would be two pricing solutions: in an implementation, the cheapest possible pricing solution of each of the two itineraries are S#1 and S#13.

At 304, the pricing graph is scanned and all GFs that are valid for fewer than K passengers are disabled (e.g., not considered). For example, if K=3, GFs valid for at most 2 passengers (e.g., 1 and 2) are disabled. Referring to the examples provided above, this would result in GFs #100, #102, and #103) being disabled. From 304, method 300 proceeds to 306.

At 306, for each diversity condition, determining if all the pricing solutions that were generated for that condition for K−1 passengers are also valid for K passengers. If so, method 300 proceeds to 308 where the diversity conditions are marked as satisfied, so that the enumeration algorithm can ignore the condition when producing pricing solutions valid for K passengers. From 308 method 300 proceeds to 310. If, however, all pricing solutions are not valid for K passengers, method 300 proceeds to 307 where valid solutions are enumerated using the remainder of the pricing graph for one or more unsatisfied diversity conditions. Note that, in some implementations, diversity conditions can be “looped” through consecutively or in parallel to determine if pricing solutions for K−1 passengers are also valid for K passengers. From 307, method 300 proceeds back to 306.

Referring to the examples provided above, for K=2, all GFs that are only valid for 1 passenger (i.e., GFs #100, #102, and #103) would be disabled. As not all pricing solutions enumerated above are valid for K=2 passengers (because S#1 is not valid for 2 passengers), 307 would be executed. Enumeration on the remainder of the pricing graph would result in pricing solutions S#5 and S#13 (again, the cheapest option for each of the two itineraries). S#5 would be added to the output of the query marked as intended for 2 passengers, and S#13 would be marked as intended for 1-2 passengers, as it was also enumerated in the K=1 iteration.

At 310, a determination is made whether K>N. If K>N, method 300 stops. If K≦N, method 300 proceeds to 304 where the normal enumeration procedure is performed on the part of the pricing graph that remained after the last execution of 304. This will produce the pricing solutions valid for K passengers. Whenever the algorithm comes across a trip that was originally output as a solution for a lower passenger count and this solution happens to be valid for K passengers as well, the solution will be immediately reused (as its price is already known to be good for K passengers). The following example covers the example above for K=3-5.

For K=3, at 304, all GFs that are only valid for 1 or 2 passengers (i.e., GFs #100, #102, #103) would be disabled.

For K=3, at 306, since all pricing solutions enumerated in the K=2 iteration are also valid for K=3 passengers, the passenger count ranges of those existing pricing solutions (i.e., S#5 and S#13) would be extended to include K=3, and 307 would be skipped. The method 300 would proceed to 308.

For K=4, at 304, all GFs that are only valid for K=1-3 passengers (i.e., GFs #1, #3, #4, #6, #100, #101, #102, #103, #104) would be disabled.

For K=4, at 306, as not all pricing solutions enumerated in the K=3 iteration are valid for K=4 passengers, 307 is executed.

For K=4, at 307, enumerate the cheapest pricing solution for each itinerary in the remainder of the pricing graph. This would result in pricing solutions S#11 and S#16. Since these pricing solutions were not enumerated before, they would both be marked as intended for K=4 passengers.

For K=5, at 304, all GFs that are only valid for K=1-4 passengers (i.e., GFs #1, #2, #3, #4, #6, #100, #101, #102, #103, #104) would be disabled.

For K=5, at 306, not all pricing solutions enumerated in the K=4 iteration are valid for K=5 passengers (namely, S#16 is not), so 307 is executed. The cheapest pricing solution is enumerated for each itinerary in the remainder of the pricing graph. This would result in pricing solutions S#11 and S#20. Since S#11 was enumerated before, its passenger count would be extended to include K=5 (i.e., it would now be marked as intended for 4-5 passengers). S#20 would be a new pricing solution and would be marked as intended for 5 passengers only.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving, by a computer, a travel search query;
retrieving, by a computer, data from a data store applicable to the received travel search query;
generating, by a computer, a plurality of itineraries from the retrieved data;
generating, by a computer, one or more availability lines associated with each itinerary of the plurality of itineraries, each availability line indicating a number of seats available for travel for each of a plurality of booking codes for one or more flights associated with each availability line and a booking code condition;
constructing, by a computer, a plurality of generated fares (GFs) from the generated itineraries, the generated availability lines, and fare data;
constructing, by a computer, generated fare combinations using the generated fares;
generating, by a computer, possible pricing solutions from the constructed generated fare combinations; and
storing, by a computer, the generated possible pricing solutions into a pricing graph.

2. The computer-implemented method of claim 1, wherein the retrieved data also includes one or more of air-carrier data, flight data, and fare data.

3. The computer-implemented method of claim 1, wherein each itinerary of the plurality of itineraries comprises an availability line including air-carrier information, a flight identifier, a booking code, a number of seats available for the booking code, and particular restrictions unique to that availability line.

4. The computer-implemented method of claim 1, comprising computing, by operation of a computer, a maximum passenger count for which a particular generated fare could be available in the context of some flight and availability line combination.

5. The computer-implemented method of claim 1, wherein a generated fare contains information about the circumstances under which a particular fare is used.

6. The computer-implemented method of claim 1, comprising efficiently representing the constructed generated fare combinations.

7. The computer-implemented method of claim 1, comprising enumerating pricing solutions from the pricing graph.

8. The computer-implemented method of claim 1, comprising selecting a group of fares that meet a plurality of diversity conditions.

9. The computer-implemented method of claim 8, wherein the diversity conditions are used to fulfill a diversity strategy for a specified number of passengers.

10. The computer-implemented method of claim 1, comprising scanning the pricing graph and disabling all generated fares that are valid for less than a specified number of passengers, K.

11. The computer-implemented method of claim 10, comprising, for each diversity condition, determining whether all pricing solutions valid for K−1 passengers are valid for K passengers.

12. The computer-implemented method of claim 11, comprising enumerating valid pricing solutions using a remainder of the pricing graph for one or more unsatisfied diversity conditions.

13. A non-transitory, computer-readable medium storing computer-readable instructions executable by a computer and configured to:
receive a travel search query;
retrieve data from a data store applicable to the received travel search query;
generate a plurality of itineraries from the retrieved data;
generate one or more availability lines associated with each itinerary of the plurality of itineraries, each availability line indicating a number of seats available for travel for each of a plurality of booking codes for one or more flights associated with each availability line and a booking code condition;
construct a plurality of generated fares (GFs) from the generated itineraries, the generated availability lines, and fare data;
construct generated fare combinations using the generated fares;
generate possible pricing solutions from the constructed generated fare combinations; and
store the generated possible pricing solutions into a pricing graph.

14. The computer-implemented medium of claim 13, wherein the retrieved data also includes one or more of air-carrier data, flight data, and fare data.

15. The computer-implemented medium of claim 13, wherein each itinerary of the plurality of itineraries comprises an availability line including air-carrier information, a flight identifier, a booking code, a number of seats available for the booking code, and particular restrictions unique to that availability line.

16. The computer-implemented medium of claim 13, comprising instructions configured to compute a maximum passenger count for which a particular generated fare could be available in the context of some flight and availability line combination.

17. The computer-implemented medium of claim 13, wherein a generated fare contains information about the circumstances under which a particular fare is used.

18. The computer-implemented medium of claim 13, comprising instructions configured to efficiently represent the constructed generated fare combinations.

19. The computer-implemented medium of claim 13, comprising instructions configured to enumerate pricing solutions from the pricing graph.

20. The computer-implemented medium of claim 13, comprising instructions configured to select a group of fares that meet a plurality of diversity conditions.

21. The computer-implemented medium of claim 20, wherein the diversity conditions are used to fulfill a diversity strategy for a specified number of passengers.

22. The computer-implemented medium of claim 13, comprising instructions configured to scan the pricing graph and disable all generated fares that are valid for less than a specified number of passengers, K.

23. The computer-implemented medium of claim 22, comprising instructions configured, for each diversity condition, to determine whether all pricing solutions valid for K−1 passengers are valid for K passengers.

24. The computer-implemented medium of claim 23, comprising instructions configured to enumerate valid pricing solutions using a remainder of the pricing graph for one or more unsatisfied diversity conditions.

25. A computer system, comprising:
A memory; and
at least one hardware processor interoperably coupled to the memory and operable to:
receive a travel search query;
retrieve data from a data store applicable to the received travel search query;
generate a plurality of itineraries from the retrieved data;
generate one or more availability lines associated with each itinerary of the plurality of itineraries, each availability line indicating a number of seats available for travel for each of a plurality of booking codes for one or more flights associated with each availability line and a booking code condition;
construct a plurality of generated fares (GFs) from the generated itineraries, the generated availability lines, and fare data;
construct generated fare combinations using the generated fares;
generate possible pricing solutions from the constructed generated fare combinations; and
store the generated possible pricing solutions into a pricing graph.

26. The computer system of claim 25, wherein the retrieved data also includes one or more of air-carrier data, flight data, and fare data.

27. The computer system of claim 25, wherein each itinerary of the plurality of itineraries comprises an availability line including air-carrier information, a flight identifier, a booking code, a number of seats available for the booking code, and particular restrictions unique to that availability line.

28. The computer system of claim 25, further operable to compute a maximum passenger count for which a particular generated fare could be available in the context of some flight and availability line combination.

29. The computer system of claim 25, wherein a generated fare contains information about the circumstances under which a particular fare is used.

30. The computer system of claim 25, further operable to efficiently represent the constructed generated fare combinations.

31. The computer system of claim 25, further operable to enumerate pricing solutions from the pricing graph.

32. The computer system of claim 25, further operable to select a group of fares that meet a plurality of diversity conditions.

33. The computer system of claim 32, wherein the diversity conditions are used to fulfill a diversity strategy for a specified number of passengers.

34. The computer system of claim 25, further operable to scan the pricing graph and disable all generated fares that are valid for less than a specified number of passengers, K.

35. The computer system of claim 34, further operable to determine, for each diversity condition, whether all pricing solutions valid for K−1 passengers are valid for K passengers.

36. The computer system of claim 35, further operable to enumerate valid pricing solutions using a remainder of the pricing graph for one or more unsatisfied diversity conditions.
